(19) United States
(12) Patent Application Publication
(10) Pub. No.: US 2011/0051060 A1
(43) Pub. Date: Mar. 3, 2011

(54) LIQUID CRYSTAL DISPLAY DEVICE

(75) Inventor: Toshio SATO, Mobara (JP)

(73) Assignee: Hitachi Displays, Ltd.

(21) Appl. No.: 12/869,235

(22) Filed: Aug. 26, 2010

(30) Foreign Application Priority Data
Aug. 27, 2009 (JP) 2009-196797

(51) Int. Cl. G02F 1/1333

(52) U.S. Cl. 349/110

(57) ABSTRACT

A liquid crystal display device includes a first substrate having pixel regions and a second substrate having color filters and a light shielding film, wherein a region where ends of the color filters adjacent to each other are not overlapped with each other is formed in a crossing region of a first light shielding film formed by overlapping the color filters and a second light shielding film formed of a black layer, and a spacer is formed in the non-overlapped region so as to stride over a boundary portion of the adjacent color filters.

### CROSS-REFERENCE TO RELATED APPLICATION

The present application claims priority from Japanese application JP 2009-196797 filed on Aug. 27, 2009, the content of which is hereby incorporated by reference into this application.

### BACKGROUND OF THE INVENTION

1. Field of the Invention

The present invention relates to a liquid crystal display and more particularly to a technology of forming a columnar spacer disposed above color filters.

2. Description of the Related Art

A liquid crystal display device includes a first substrate on which thin film transistors are formed and a second substrate on which color filters are formed. The first substrate and the second substrate which are disposed to face each other via a liquid crystal layer are bonded together with a sealing material, thereby forming the liquid crystal display device. For maintaining the gap between the first substrate and the second substrate at a predetermined gap, columnar spacers are disposed in a matrix in a display region between the first substrate and the second substrate. That is, the columnar spacers having the same height as the gap (cell gap) between the first substrate and the second substrate are formed in a region in which liquid crystal is sealed. In this case, the columnar spacers are formed in a region of a light shielding film (black matrix) so that the columnar spacers give no influence on image display.

FIG. 12 is a top view of the forming portion of a columnar spacer in a conventional liquid crystal display device. FIG. 13 is a cross-sectional view taken along line F-F of FIG. 12. FIG. 14 is a cross-sectional view taken along line G-G of FIG. 12. As is apparent from FIGS. 12 and 13, in the conventional liquid crystal display device, each of color filters is formed on the side of a pixel adjacent in the lateral direction in the drawing so as to cross over the boundary position (pitch center) between adjacent pixels shown by the dashed-dotted line, the adjacent color filters (a blue (B) color filter CFB and a green (G) color filter CFG in the drawing) are overlapped with each other, and a protective film OC is formed on the color filters CFB and CFG. With such a configuration, the overlapped region is used as a light shielding film. Such a technology of using the adjacent color filters as a light shielding film BM is described in JP-A-2002-268060 (corresponding to U.S. Pat. No. 6,657,682).

As is apparent from FIGS. 12 and 14, on the other hand, in a region where a columnar spacer SOC is disposed, the color filters CFG and CFB are formed on the light shielding film BM. In this case, for planarizing an underlayer in the forming portion of the columnar spacer SOC, in the forming region of the light shielding film BM, a region where the B color filter CFB largely protrudes to the side of the adjacent G color filter CFG is formed, and the columnar spacer SOC is formed in the protruded region above the color filter CFB via the protective film OC. In the region where the B color filter CFB protrudes, a region where an end of the adjacent G color filter CFG is dented along the protruding shape of the B color filter CFB is formed. In the region, the overlapped portion is not formed. Such a technology of forming the protruded region on one side of the adjacent color filter and forming the columnar spacer in the protruded region is described in JP-A-2003-280000.

### SUMMARY OF THE INVENTION

In the conventional liquid crystal display device described above, however, when a photomask for the B color filter CFB is shifted in a direction of arrow in the drawing (upward direction in the drawing) in forming the B color filter CFB as shown in FIG. 15, the B color filter CFB is formed also at a position shifted in the direction of arrow in the drawing. When a convex portion of the B color filter CFB is shifted beyond the light shielding film BM, a mixed color region MOC where the B color filter CFB and the G color filter CFG are overlapped with each other to cause color mixture is formed also in a pixel region. Especially in a liquid crystal display device in which respective color filters of R, G, and B are disposed in a stripe shape in a direction of a video signal line (drain line), since the mixed color region MOC is formed in pixels of one column, there is a problem that the display quality is greatly reduced.

For preventing the reduction in display quality caused by the misalignment of the color filter, the width of the light shielding film BM in the shift direction (vertical direction in the drawing) is conventionally increased as shown in FIG. 16, whereby light of a backlight transmitting through the region where the misalignment is generated is blocked. However, when the width of the light shielding film is increased, there is a problem that the transmittance ratio of the liquid crystal display device is reduced along with an increase of the light shielding film, that is, the aperture ratio of a pixel is reduced.

The invention has been made in view of the problem, and it is an object of the invention to provide a liquid crystal display device in which the base region of a columnar spacer can be planarized and the transmittance ratio can be improved.

(1) In order to solve the problem, a liquid crystal display device includes: a first substrate which has pixel regions each surrounded by drain lines and gate lines; and a second substrate which is disposed to face the first substrate and on which color filters corresponding to pixels, a light shielding film, and a spacer maintaining the gap between the first substrate and the second substrate at a predetermined gap are formed, wherein the light shielding film has a first light shielding film formed by overlapping the color filters and a second light shielding film formed of a black resin or a metal material, the first light shielding film extends in a first direction, the second light shielding film extends in a second direction crossing the first light shielding film, a region where ends of the color filters adjacent to each other are not overlapped with each other is formed in a crossing region of the first light shielding film and the second light shielding film, and the spacer is formed above the color filters in the crossing region of the first light shielding film and the second light shielding film and disposed so as to stride over a boundary portion of the adjacent color filters in the region where the ends of the adjacent color filters are not overlapped with each other.

(2) In order to solve the problem, a liquid crystal display device includes: a first substrate which has pixel regions each surrounded by drain lines and gate lines; and a second substrate which is disposed to face the first substrate and on which color filters corresponding to pixels, a light shielding film, and a spacer maintaining the gap between the first substrate and the second substrate at a predetermined gap are formed, wherein the light shielding film has a first light shielding film formed by overlapping the color filters and a second light shielding film formed of a black resin or a metal material, the first light shielding film extends in a first direction, the second light shielding film extends in a second direction crossing the first light shielding film, a region where side surfaces of the color filters adjacent to each other on the adjacent side are in contact with each other along the extending direction of the first light shielding film is provided in a crossing region of the first light shielding film and the second light shielding film, and the spacer is formed above the color filters so as to stride over a boundary portion of the adjacent color filters in the region where the side surfaces are in contact with each other.

According to the invention, it is possible to planarize the base region of a spacer and to improve the transmittance ratio of a liquid crystal display device.

Other advantages of the invention will become apparent from the entire description of the specification.

### BRIEF DESCRIPTION OF THE DRAWINGS

FIG. 1 explains the schematic configuration of a liquid crystal display device of an embodiment of the invention.

FIG. 2 explains the schematic configuration of a pixel in the liquid crystal display device of the embodiment of the invention.

FIG. 3 is a cross-sectional view taken along line A-A shown in FIG. 2.

FIG. 4 is a top view of the forming portion of a columnar spacer in the liquid crystal display device of the embodiment of the invention.

FIG. 5 is a cross-sectional view of a thin film portion taken along line B-B shown in FIG. 4.

FIG. 6 is a cross-sectional view of the thin film portion taken along line C-C shown in FIG. 4.

FIG. 7 is an enlarged view of a frame portion b shown in FIG. 4.

FIG. 8 is a top view when a color filter is misaligned in the liquid crystal display device of the embodiment of the invention.

FIG. 9 is a cross-sectional view of an overlapped portion taken along line D-D shown in FIG. 8.

FIG. 10 is a top view of the forming portion of a columnar spacer when the color filter is misaligned in the liquid crystal display device of the embodiment of the invention.

FIG. 11 is a cross-sectional view taken along line E-E shown in FIG. 10.

FIG. 12 is a top view of the forming portion of a columnar spacer in a conventional liquid crystal display device.

FIG. 13 is a cross-sectional view taken along line F-F shown in FIG. 12.

FIG. 14 is a cross-sectional view taken along line G-G shown in FIG. 12.

FIG. 15 is a top view when a color filter is misaligned in the conventional liquid crystal display device.

FIG. 16 is a top view of the forming portion of a columnar spacer when the width of a light shielding film is increased in the conventional liquid crystal display device.

FIG. 17 is a top view of the forming portion of a columnar spacer in the liquid crystal display device of the embodiment of the invention.

FIG. 18 is a cross-sectional view of a thin film portion taken along line B-B shown in FIG. 17.

### DESCRIPTION OF THE PREFERRED EMBODIMENTS

Hereinafter, an embodiment to which the invention is applied will be described with reference to the drawings. In the following description, however, the same constituent element is denoted by the same reference numeral and sign, and the repetitive description thereof is omitted.

### <Overall Configuration>

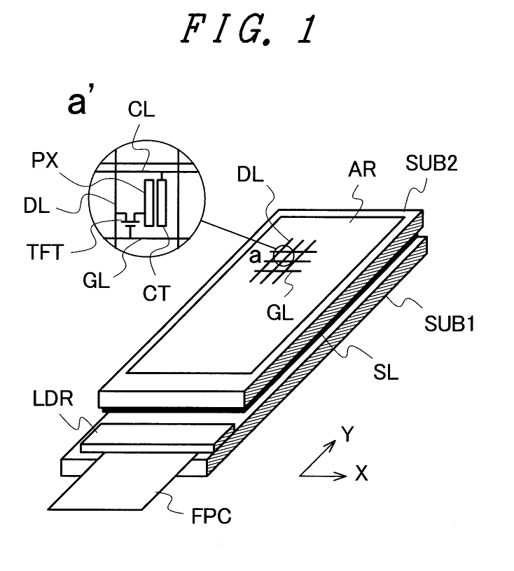

FIG. 1 explains the schematic configuration of a liquid crystal display device of the embodiment of the invention. Hereinafter, the configuration of the liquid crystal display device of the embodiment will be described based on FIG. 1.

As shown in FIG. 1, a first substrate (TFT side substrate) SUB1 on which pixel electrodes, thin film transistor, and the like are formed, a second substrate (counter substrate) SUB2 which is disposed so as to face the first substrate SUB1 and on which color filters (colored layers), alight shielding film (black matrix), and the like are formed, and a later-described liquid crystal layer which is interposed between the first substrate SUB1 and the second substrate SUB2 constitute a panel part. A not-shown backlight unit serving as a light source is combined with the panel part, whereby the liquid crystal display device of the embodiment is formed. The first substrate SUB1 and the second substrate SUB2 are fixed (adhered) to each other by a sealing material SL formed at the periphery of a display region AR, and also liquid crystal interposed between the two substrates SUB1 and SUB2 is sealed by the sealing material SL.

The first substrate SUB1 and the second substrate SUB2 are not limited to, for example, a well-known glass substrate, but may be another insulating substrate such as quartz glass or plastic (resin). For example, since the use of quartz glass makes it possible to increase a process temperature, a gate insulating film of a thin film transistor TFT can be densified. Therefore, the reliability of the thin film. transistor TFT can be improved. When a plastic (resin) substrate is used, a liquid crystal display device which is light in weight and excellent in impact resistance can be formed.

In the liquid crystal display device of the embodiment, a region where display pixels (hereinafter abbreviated as pixels) are formed inside the region in which liquid crystal is sealed serves as the display region AR. Accordingly, a region where the pixels are not formed and which does not relate to display does not serve as the display region AR even inside the region in which liquid crystal is sealed. Further in the liquid crystal display device of the embodiment, a drive circuit LDR mounted on the first substrate SUB1 includes a video signal drive circuit and a scanning signal drive circuit, and performs drive output in accordance with an input signal input from a flexible printed board FPC.

In the liquid crystal display device of the embodiment as shown in FIG. 1, scanning signal lines (gate lines) GL extending in the X-direction in the drawing and arranged in parallel in the Y-direction are formed inside the display region AR on a surface of the first substrate SUB1 on the liquid crystal side. Moreover, video signal lines (drain lines) DL extending in the Y-direction in the drawing and arranged in parallel in the X-direction are formed. Each of rectangular regions surrounded by the drain lines DL and the gate lines GL constitutes a region where a pixel is formed. With this configuration, the pixels are arranged in a matrix inside the display region AR. In the pixel region of the second substrate SUB2, any of not-shown color filters of red (R), green (G), and blue (B) is formed. The pixels of R, G, and B form a unit pixel for color display.

As shown in an enlarged view a′ of a circle portion a in FIG. 1 for example, each pixel includes the thin film transistor TFT which is turned on in response to a scanning signal from the gate line GL, a pixel electrode PX which is supplied with a video signal from the drain line DL via the turned-on thin film transistor TFT, and a common electrode CT which is connected to a common line CL and supplied with a reference signal having a potential as a reference with respect to a potential of the video signal. An electric field having a component parallel to the surface of the first substrate SUB1 is generated between the pixel electrode PX and the common electrode CT. With this electric field, liquid crystal molecules in the liquid crystal layer are driven. Such a liquid crystal panel is known as one which can perform the so-called wide viewing angle display. Because of its specific application of the electric field to liquid crystal, the liquid crystal panel is called of an IPS type or a lateral electric field type.

Each of the drain lines DL and gate lines GL extend over the sealing material SL at their ends and are connected to the drive circuit LDR. In the liquid crystal display device of the embodiment, the drive circuit LDR is formed of a semiconductor chip and mounted on the first substrate SUB1. However, the drive circuit LDR may be directly formed on the first substrate SUB1, or may be mounted on the flexible printed board FPC by a tape carrier method or a COF (Chip On Film) method to be connected to the first substrate SUB1.

### <Configurations of Pixel and Columnar Spacer>

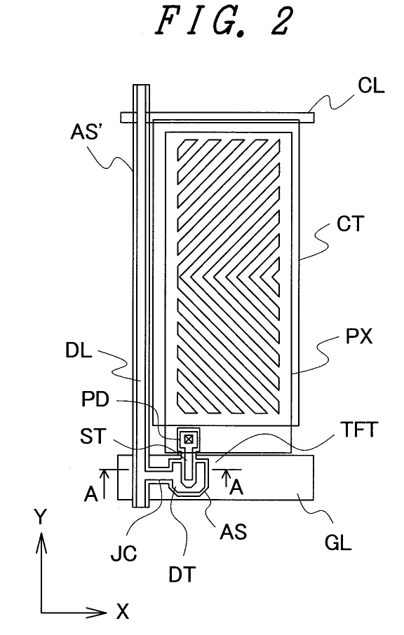

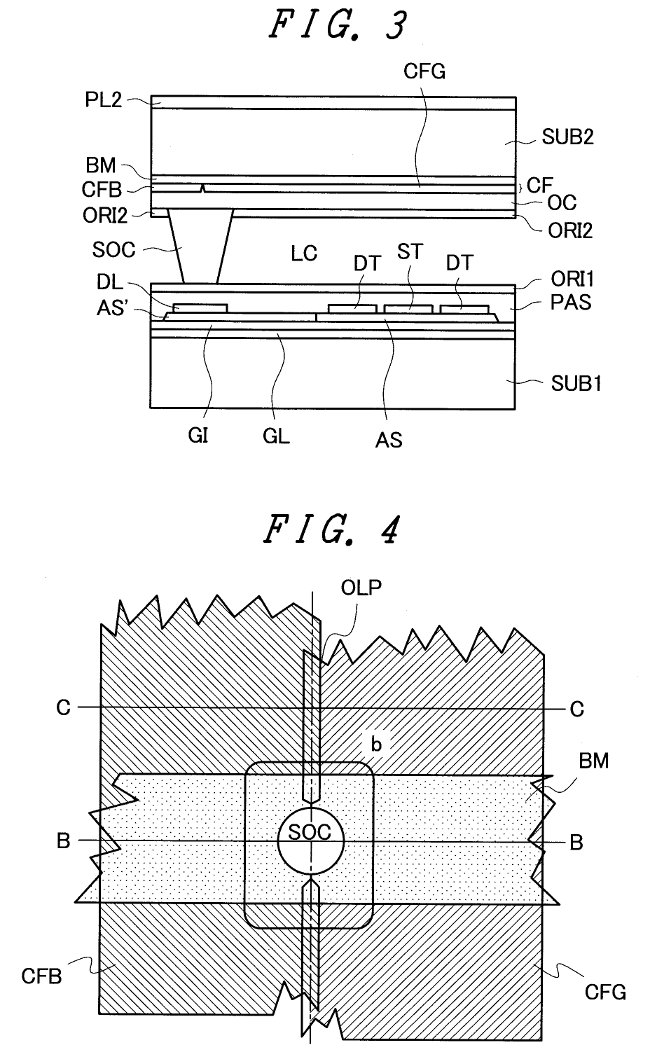

FIG. 2 explains the schematic configuration of a pixel in the liquid crystal display device of the embodiment of the invention. FIG. 3 shows a cross-sectional view taken along line A-A shown in FIG. 2. Hereinafter, the schematic configurations of the pixel and a columnar spacer in the liquid crystal display device of the embodiment will be described based on FIGS. 2 and 3.

As shown in FIG. 2, the gate line GL and the common line CL are formed in parallel with a relatively large distance on the surface (facing surface) of the first substrate SUB1 on the liquid crystal side. In the region between the gate line GL and the common line CL, the counter electrode CT formed of a transparent conductive material such as, for example, ITO (Indium-Tin-Oxide) is formed. The counter electrode CT is formed so as to overlap with the common line CL at the side portion thereof on the common line CL side and therefore electrically connected to the common line CL.

As shown in FIG. 3, an insulating film GI is formed on the surface of the first substrate SUB1 so as to cover the gate line GL, the common line CL, and the counter electrode CT. The insulating film GI functions as a gate insulating film of the thin film transistor TFT, which will be described later, in the forming region of the thin film transistor TFT, and the thickness or the like of the insulating film is set in accordance with the gate insulating film.

An amorphous semiconductor layer AS formed of, for example, amorphous silicon is formed on the upper surface of the insulating film GI at a portion overlapping with a part of the gate line GL. The semiconductor layer AS serves as a semiconductor layer of the thin film transistor TFT. The semiconductor layer AS is formed below the drain signal line DL, below a connecting portion JC, and below an extended portion (including a pad PD) of a source electrode ST, for example, as indicated by AS′ (hereinafter referred to as an amorphous silicon layer), so that a difference in level can be reduced.

The drain line DL is formed so as to extend in the Y-direction in the drawing. The drain line DL has at a part thereof an extended portion (the connecting portion JC) extending to the thin film transistor TFT side. The extended portion is connected to a drain electrode DT of the thin film transistor TFT formed on the semiconductor layer AS. The drain line DL crosses the gate line GL via the insulating film GI and the amorphous silicon layer AS′ in a region in the vicinity of the thin film transistor TFT.

The source electrode ST which is formed simultaneously when the drain line DL and the drain electrode DT are formed is formed so as to face the drain electrode DT on the semiconductor layer AS and to include the extended portion slightly extended from a portion above the semiconductor layer AS to the pixel region side. The extended portion reaches the pad PD connected to the pixel electrode PX.

The drain electrode DT is formed into, for example a U-shaped pattern so as to surround a distal end portion of the source electrode ST. With this configuration, a channel width of the thin film transistor TFT can be made large.

The thin film transistor TFT is formed as a transistor having the so-called inverse-staggered type MIS (Metal Insulator Semiconductor) structure in which the gate line GL is used as a gate electrode. The transistor having the MIS structure is driven in such a manner that the drain electrode DT and the source electrode ST are exchanged depending on an applied bias voltage. In the specification, however, an electrode which is connected to the drain line DL is referred to as the drain electrode DT, and an electrode which is connected to the pixel electrode PX is referred to as the source electrode ST for convenience.

On the surface of the first substrate SUB1, a protective film PAS formed of an insulating film is formed so as to cover the thin film transistor TFT. The protective film PAS is provided for preventing direct contact between the thin film transistor TFT and liquid crystal. The protective film PAS is intervened between the counter electrode CT and the pixel electrode PX and functions also as a dielectric film for a capacitive element which is formed between the counter electrode CT and the pixel electrode PX together with the insulating film GI.

The pixel electrode PX is formed on the upper surface of the protective film PAS. The pixel electrode PX is formed of a transparent conductive film such as, for example, ITO and formed so as to overlap with the counter electrode CT over a wide area. A large number of slits are formed in the pixel electrode PX so as to be arranged in parallel in a direction crossing the longitudinal direction of the slits. With this configuration, the pixel electrode PX is formed to include a group of electrodes formed of a large number of linear electrodes having respective both ends thereof connected with each other.

The thus formed pixel electrode PX is electrically connected at the side portion thereof on the thin film transistor TFT side to the pad PD of the source electrode ST of the thin film transistor TFT via a not-shown through hole formed in the protective film PAS. Further, an alignment film ORI1 is formed on the surface of the first substrate SUB1 so as to cover the facing surface side including the pixel electrode PX.

Next, the second substrate SUB2 which is disposed to face the first substrate SUB1 via a liquid crystal layer LC will be described.

As shown in FIG. 3, a black matrix (light shielding film) BM, color filters (colored layers) CF, an protective film (overcoat layer) OC, a columnar spacer SOC, and an alignment film ORI2 are stacked in this order on a surface (facing surface) of the second substrate SUB2 on the liquid crystal side. For distinguishing the respective color filters CF of R, G, and B in the specification, the color filter CF of red (R), the color filter CF of green (G), and, the color filter CF of blue (B) are respectively referred to as a color filter CFR, a color filter CFG, and a color filter CFB.

The black matrix BM is formed along the periphery of each pixel on the surface of the second substrate SUB2. Any of the color filters CF of R, G, and B corresponding to each pixel is formed on the black matrix BM (lower side in the drawing). In the liquid crystal display device of the embodiment in this case, in the peripheral portion of the color filter CF formed in each pixel, adjacent ends of the color filters CF of different colors are overlapped with each other, and the overlapped portion of the color filters CF is used as a light shielding film.

Especially in the liquid crystal display device of the embodiment, the respective color filters CFR, CFG, and CFB of R, G, and B are formed such that the color filters having the same color are formed in a stripe shape in the extending direction of the drain line DL and the respective color filters CFR, CFG, and CFB of R, G, and B are sequentially arranged in parallel in the extending direction of the gate line GL. That is, the overlapped portion of the adjacent color filters CF is formed at a position corresponding to the drain line DL of the first substrate SUB1. With this configuration, the overlapped portion is used as a light shielding film (first light shielding film) overlapped with the drain line DL. The detailed configuration of the overlapped portion of the adjacent color filters CF at the ends thereof will be described later.

In the liquid crystal display device of the embodiment, the black matrix (second light shielding film) BM is formed at a position corresponding to the forming region of the gate line GL and the thin film transistor TFT.

Further in the liquid crystal display device of the embodiment, the columnar spacer SOC is disposed at a predetermined position inside a crossing region of the extending direction of the overlapped portion of the adjacent color filters CF and the black matrix BM. In the embodiment in this case, in the crossing region where the columnar spacer SOC is disposed, an end of the B color filter CFB and an end of the G color filter CFG, which are the color filters CF disposed adjacent to each other, are not overlapped with each other as shown in FIG. 3. That is, in the base region of the columnar spacer SOC, a side surface of the B color filter CFB at the end and a side surface of the G color filter CFG at the end, which are arranged adjacent to each other, are formed so as to face each other, and at least parts thereof are in contact with each other. Therefore, the overlapped portion is not formed, and the side surfaces coincide with each other or are overlapped with each other to such an extent that unevenness is not formed. Further, it is preferable that the entire or a part of region of the side surfaces of the adjacent color filters CFB and CFG is formed so as to extend with no gap in a direction of the boundary between the adjacent pixels shown by the dashed-dotted line. The detailed configuration of the adjacent color filters CF at the ends will be described later.

With such a configuration, the base region of the columnar spacer SOC can be planarized, and the gap (cell gap) between the first substrate SUB1 and the second substrate SUB2 can be maintained with good accuracy. As a result, it is possible to improve the display quality of an image. In the embodiment, although the case where the color filters are arranged in a stripe-shaped pattern of R, G, and B has been described, this is not restrictive. The color filter CF may be formed for each pixel.

The protective film OC is formed on the color filters CFB and CFG. For example, the protective film OC is formed by applying an acrylic resin. The columnar spacer SOC is formed on the protective film OC, and the alignment film ORI2 for liquid crystal containing, for example, a polyimide material as a main component is formed so as to cover the protective film OC. For the formation of the alignment film ORI2, for example, a well-known flexographic printing or inkjet coating film formation method can be used.

On both outer surfaces of the substrates of the liquid crystal panel, which is formed of the first substrate SUB1 and the second substrate SUB2 disposed so as to face each other via the liquid crystal layer LC, a not-shown polarizer on the first substrate SUB1 side and a polarizer PL2 on the second substrate SUB2 side are respectively disposed.

### <Detailed Configuration of Overlapped Portion of Color Filters>

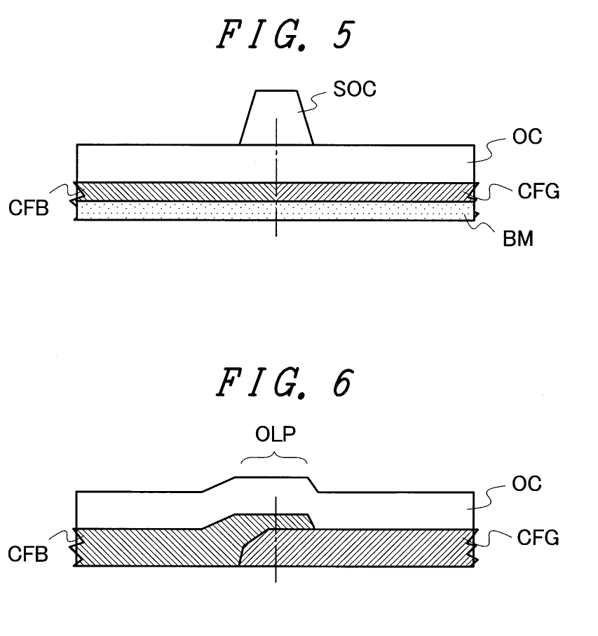

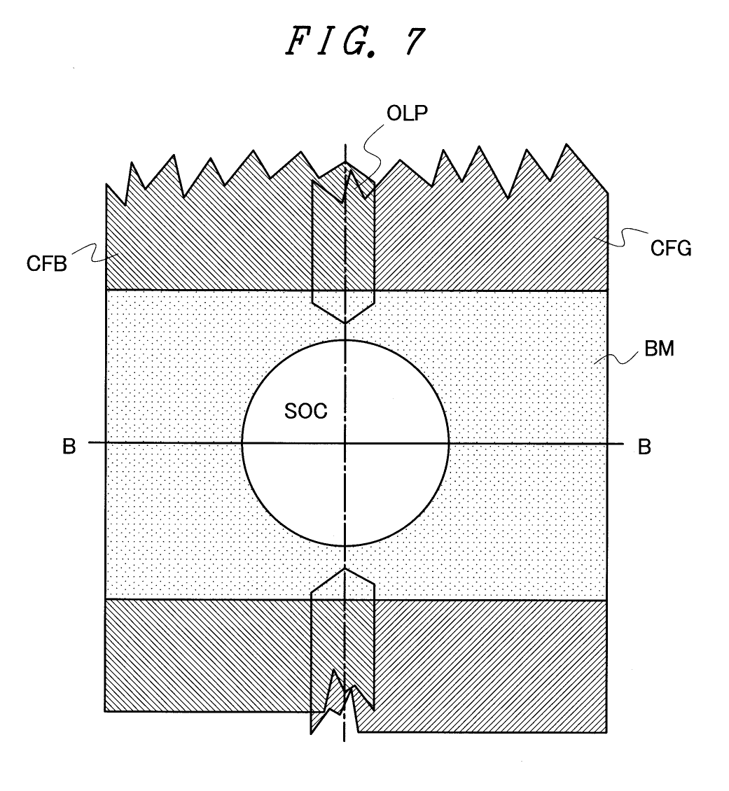

FIG. 4 shows a top view of the forming portion of a columnar spacer in the liquid crystal display device of the embodiment of the invention. FIG. 5 shows a cross-sectional view of a thin film portion taken along line B-B shown in FIG. 4. FIG. 6 shows a cross-sectional view of the thin film portion taken along line C-C shown in FIG. 4. FIG. 7 shows an enlarged view of a frame portion b shown in FIG. 4. Hereinafter, the end structure of color filters disposed adjacent to each other in the embodiment will be described based on FIGS. 4 to 7. The dashed-dotted line shown in FIGS. 4 to 7 shows the boundary position (pitch center) between the adjacent pixels. Cross-sectional views shown in FIGS. 5 and 6 show only thin films formed on the second substrate shown in FIG. 3, and the thin films are shown upside down from those in FIG. 3.

As shown in FIG. 4, in the liquid crystal display device of the embodiment, the columnar spacer SOC is formed in a crossing region of an extension of an overlapped portion OLP of the adjacent color filters CF and the black matrix BM. With such a configuration, the influence of the columnar spacer SOC on transmitted light through each pixel is reduced.

As is apparent from FIGS. 4 and 6, in a region where the black matrix BM is not formed, the color filter CF of the embodiment is formed on the side of the adjacent pixel so as to cross over the boundary position between the adjacent pixels shown by the dashed-dotted line. The end of the B color filter CFB is formed on the end of the G color filter CFG so as to overlap therewith, whereby the overlapped portion OLP is formed. The protective film OC is formed on the color filters CFB and CFG. With such a configuration, the overlapped region (overlapped portion) OLP is used as a light shielding film.

Especially in the region where the black matrix BM is not formed, the B color filter CFB and the G color filter CFG are directly formed on the facing surface side of the second substrate, which is not shown, and the ends of the color filter CFB and the color filter CFG are overlapped with each other. In the embodiment in this case, after the formation of the B color filter CFB, the G color filter CFG is formed. As a result, as shown in FIG. 6, the G color filter CFG is formed on the B color filter CFB so as to overlap therewith in the overlapped portion OLP. The order of the color filters CF in the vertical direction in the overlapped portion OLP is appropriately changed in accordance with the forming order of the color filters CF of R, G, and B.

As is apparent from FIGS. 4 and 5, on the other hand, in a region where both the black matrix BM and the columnar spacer SOC are formed, the color filters CFB and CFG are formed on the black matrix BM. In the embodiment in this case, for planarizing the end region of the B color filter CFB and the G color filter CFG serving as the base portion of the forming portion of the columnar spacer SOC, the overlapped portion OLP of the ends of the color filters CF is not formed.

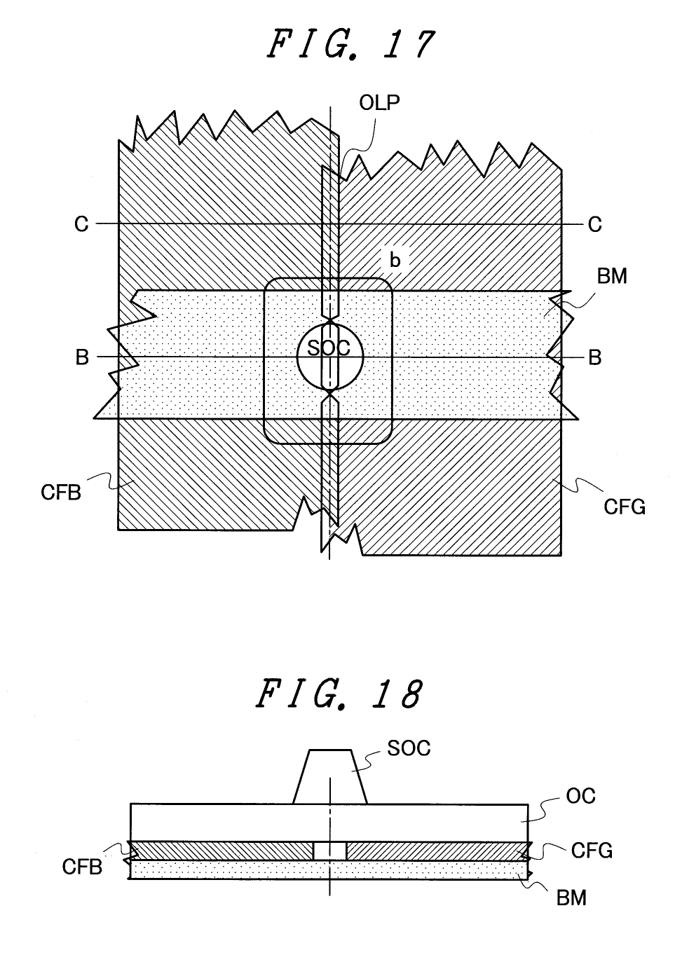

The configuration in which the overlapped portion OLP is not formed includes a configuration in which the end of the B color filter CFB and the end of the G color filter CFG are separate from each other under the columnar spacer SOC and a configuration in which the ends are in contact with each other. FIG. 5 shows an example of the configuration of contact. FIGS. 17 and 18 show an example of the configuration of separation.

That is, in the crossing region where the columnar spacer SOC is disposed, the end of the B color filter CFB and the end of the G color filter CFG, which are the color filters CF disposed adjacent to each other, are not overlapped with each other as shown in FIG. 5. In this case, the side surface of the B color filter CFB at the end and the side surface of the G color filter CFG at the end adjacent to each other are disposed to face each other on the black matrix BM. That is, at least respective parts of the side surface portions at the ends are in contact with each other, whereby the overlapped portion is not formed, and the side surfaces can coincide with each other, or they can be overlapped with each other to such an extent that unevenness is not formed. Therefore, it is possible to planarize the base portion of the forming portion of the columnar spacer SOC and to prevent light leakage caused by the misalignment of the color filter CF in the extending direction of the overlapped portion OLP.

That is, the entire or a part of region of the side surfaces of the adjacent color filters CFB and CFG extends with no gap in a direction of the boundary between the adjacent pixels shown by the dashed-dotted line, whereby it is possible to planarize the base region of the columnar spacer SOC and to maintain the gap between the first substrate SUB1 and the second substrate SUB2 with good accuracy. Further, it is possible to prevent light leakage caused by the misalignment of the color filter CF in the extending direction of the overlapped portion OLP. As a result, the display quality of an image can be improved.

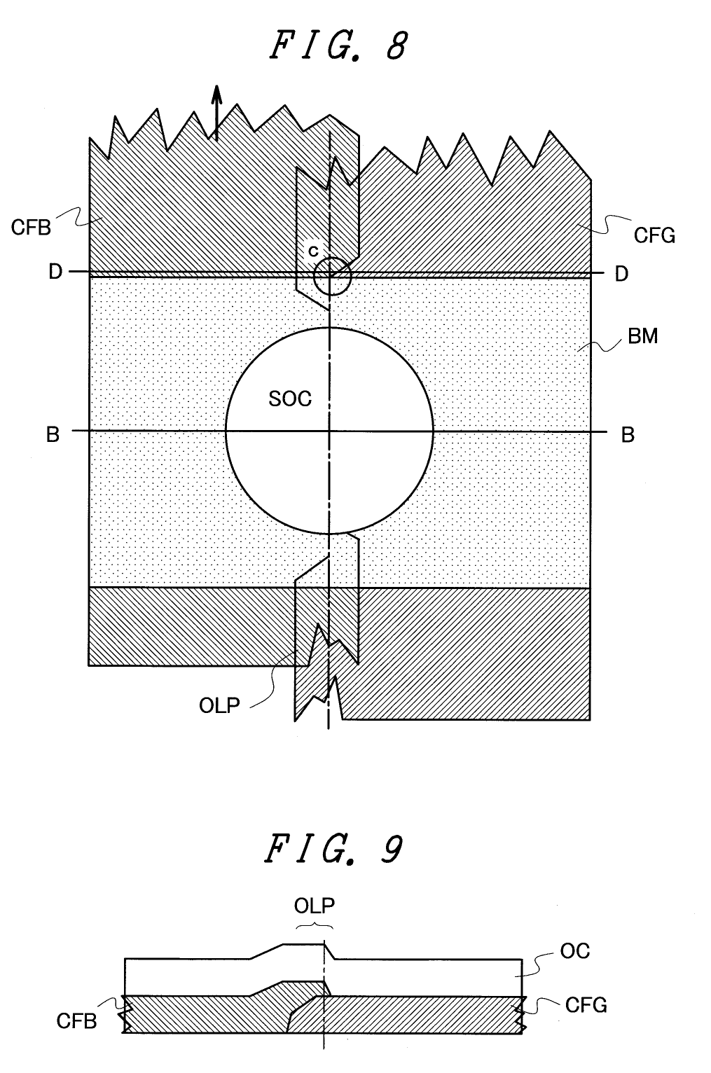

FIG. 8 shows a top view when the color filter is misaligned in the liquid crystal display device of the embodiment of the invention. FIG. 9 shows a cross-sectional view of the overlapped portion taken along line D-D shown in FIG. 8. Hereinafter, the case where the color filter CF is shifted in the extending direction of the overlapped portion OLP will be described based on FIGS. 7 to 9.

In forming the B color filter CFB, when a photomask for the B color filter CFB is shifted in a direction of arrow in the drawing (upward direction in the drawing), the B color filter CFB is formed at a position shifted in the upward direction in the drawing which is the extending direction of the overlapped portion OLP also in the embodiment in the same manner as the conventional case. In this case, as shown in a circle portion c of FIG. 8, in the end of the B color filter CFB, the end which is to be formed in a region not crossing over the boundary between the adjacent pixels shown by the dashed-dotted line is shifted beyond the region of the black matrix BM. When the end which is formed originally in the forming region of the black matrix BM is shifted beyond the black matrix BM, the end of the B color filter CFB which is to be formed on the side of the G color filter CFG so as to cross over the boundary between the adjacent pixels shown by the dashed-dotted line is not present.

As shown in FIG. 9, however, also the G color filter CFG is formed on the forming region side of the B color filter CFB so as to cross over the boundary between the adjacent pixels shown by the dashed-dotted line. Therefore, the end of the G color filter CFG and the overlapped portion OLP having the width to the boundary portion between the adjacent pixels shown by the dashed-dotted line are present. That is, only the width of the overlapped portion OLP is narrowed, and the function of the overlapped portion OLP as a light shielding film is maintained. Therefore, it is possible without increasing the width of the black matrix BM to prevent the generation of a mixed color region where color mixture is caused as is the case in the conventional liquid crystal display device.

Especially in the liquid crystal display device of the embodiment, since the overlapped portion OLP can be formed irrespective of the amount of misalignment of the color filter CF, the width of the black matrix BM can be made smaller than a width determined in view of alignment accuracy in forming the color filter CF. As a result, it is possible to improve the aperture ratio while preventing a reduction in display quality of the liquid crystal display device.

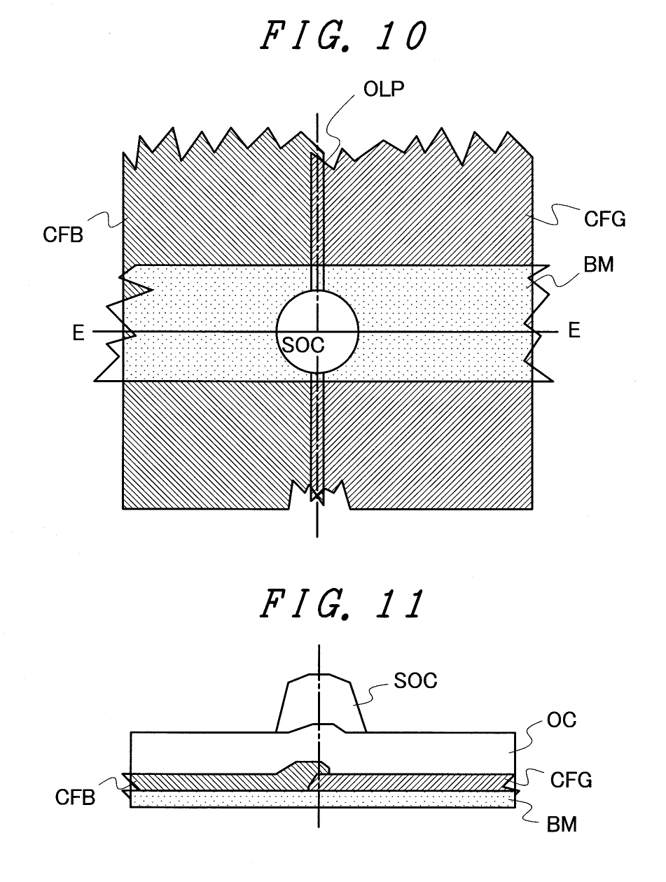

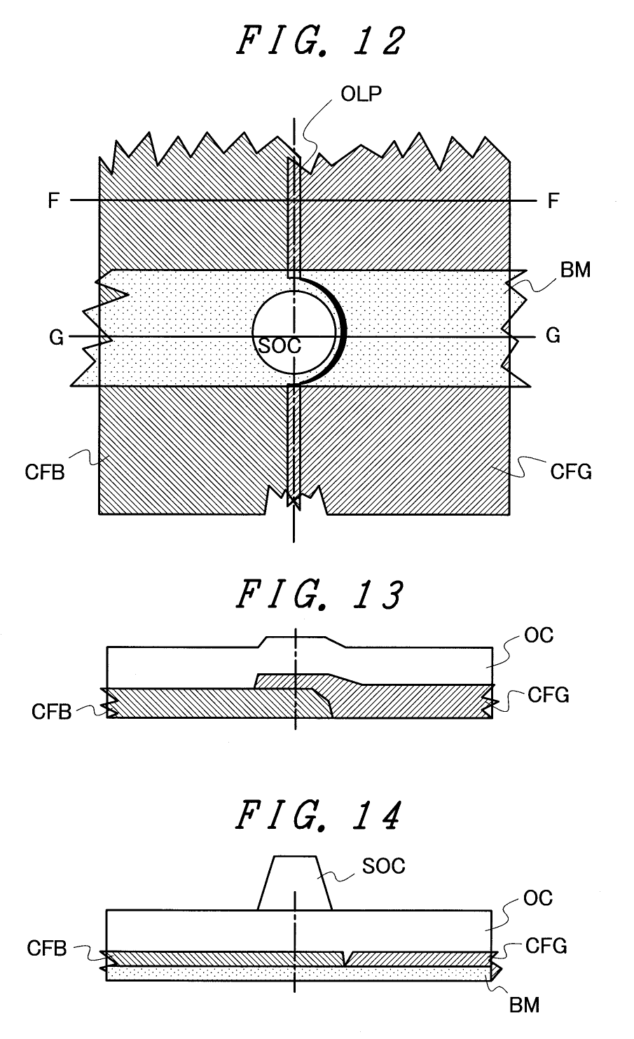

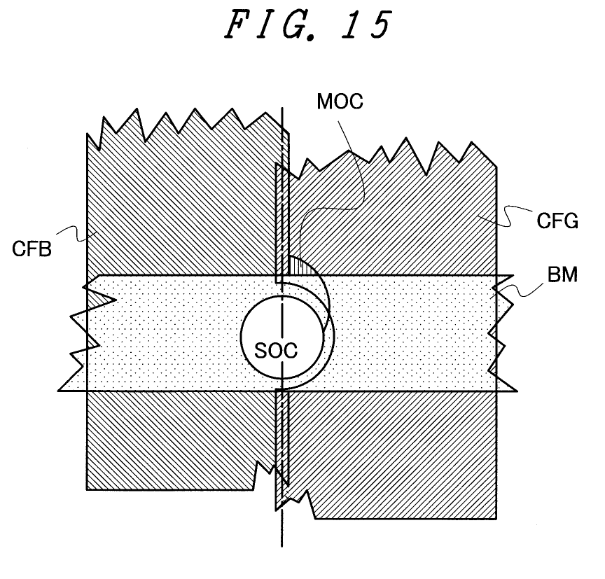

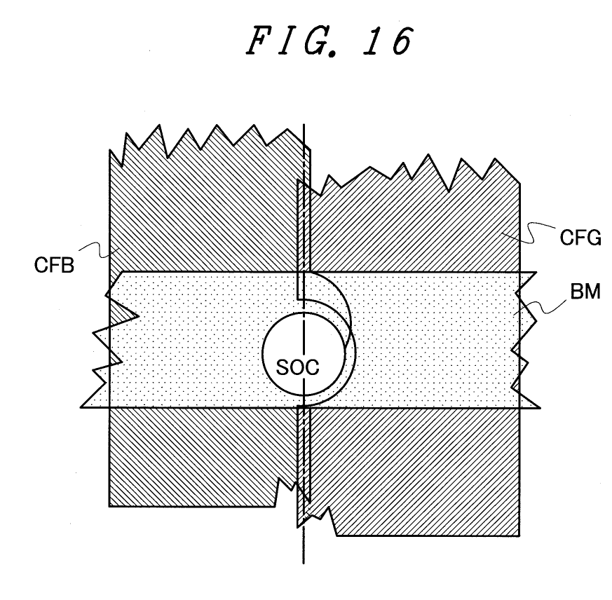

As shown in FIG. 10, it is also possible to form the columnar spacer SOC in the overlapped portion OLP of the B color filter CFB and the G color filter CFG, adjacent to each other. However, as is apparent from FIG. 11 which is a cross-sectional view taken along ling E-E shown in FIG. 10, unevenness is formed on the upper surface side (upper side in the drawing) of the protective film OC in accordance with the overlapping shape of the overlapped portion OLP. As a result, the upper base shape of the columnar spacer SOC, that is, the protective film OC of the columnar spacer SOC also has the uneven shape. Further, since the black matrix BM, the B color filter CFB, the G color filter CFG, and the protective film OC are formed in a stacked manner below the columnar spacer SOC, the accuracy of the cell gap is reduced, resulting in fear that the display quality is reduced.

As described above, in the liquid crystal display device of the embodiment of the invention, a light shielding film is formed by using the overlapped region OLP in which the ends of the adjacent color filters CF, among the stripe-shaped color filters CF extended in the same direction as the drain line DL, are disposed so as to overlap with each other, and the black matrix BM which crosses the overlapped region OLP is formed of a black resin or a metal material. In the crossing region of the overlapped portion OLP and the black matrix BM, the region where the ends of the color filters CF are not overlapped with each other is formed. In the non-overlapped region, the columnar spacer is formed so as to stride over the boundary portion of the adjacent color filters CF, that is, the portion where the ends of the adjacent color filters CF are disposed to face each other. Therefore, it is possible to planarize the base region of the columnar spacer and to improve the transmittance ratio of the liquid crystal display device.

The invention made by the present inventor has been specifically described based on the embodiment of the invention. However, the invention is not limited to the embodiment of the invention and can be variously modified within a range not departing from the gist thereof.

What is claimed is:

1. A liquid crystal display device comprising:
a first substrate which has pixel regions each surrounded by drain lines and gate lines; and
a second substrate which is disposed to face the first substrate and on which color filters corresponding to pixels, a light shielding film, and a spacer maintaining the gap between the first substrate and the second substrate at a predetermined gap are formed, wherein
the light shielding film has a first light shielding film formed by overlapping the color filters and a second light shielding film formed of a black resin or a metal material,
the first light shielding film extends in a first direction, the second light shielding film extends in a second direction crossing the first light shielding film,
a region where ends of the color filters adjacent to each other are not overlapped with each other is formed in a crossing region of the first light shielding film and the second light shielding film, and
the spacer is disposed so as to stride over a boundary portion of the adjacent color filters in the region where the ends of the adjacent color filters are not overlapped with each other in the crossing region of the first light shielding film and the second light shielding film.

2. A liquid crystal display device comprising:
a first substrate which has pixel regions each surrounded by drain lines and gate lines; and
a second substrate which is disposed to face the first substrate and on which color filters corresponding to pixels, a light shielding film, and a spacer maintaining the gap between the first substrate and the second substrate at a predetermined gap are formed, wherein
the light shielding film has a first light shielding film formed by overlapping the color filters adjacent to each other and a second light shielding film formed of a black resin or a metal material,
the first light shielding film extends in a first direction, the second light shielding film extends in a second direction crossing the first light shielding film,
a region where side surfaces of the adjacent color filters on the adjacent side are in contact with each other along the extending direction of the first light shielding film is provided in a crossing region of the first light shielding film and the second light shielding film, and
the spacer is formed above the color filters so as to stride over a boundary portion of the adjacent color filters in the region where the side surfaces are in contact with each other.

3. The liquid crystal display device according to claim 1, wherein
the light shielding film includes a first light shielding film extending in the extending direction of the drain line and arranged in parallel in the extending direction of the gate line and a second light shielding film extending in the extending direction of the gate line and arranged in parallel in the extending direction of the drain line.

4. The liquid crystal display device according to claim 2, wherein
the light shielding film includes a first light shielding film extending in the extending direction of the drain line and arranged in parallel in the extending direction of the gate line and a second light shielding film extending in the extending direction of the gate line and arranged in parallel in the extending direction of the drain line.

5. The liquid crystal display device according to claim 3, wherein
in the region where the ends of the adjacent color filters are not overlapped with each other, respective surfaces of the adjacent color filters at the ends are contained in an identical plane.

6. The liquid crystal display device according to claim 4, wherein
in the region where the ends of the adjacent color filters are not overlapped with each other, respective surfaces of the adjacent color filters at the ends are contained in an identical plane.

7. The liquid crystal display device according to claim 5, wherein
in the region where the ends of the adjacent color filters are not overlapped with each other, the adjacent color filters are formed so as not to generate unevenness at a boundary between the ends of the adjacent color filters.

8. The liquid crystal display device according to claim 6, wherein
in the region where the ends of the adjacent color filters are not overlapped with each other, the adjacent color filters are formed so as not to generate unevenness at a boundary between the ends of the adjacent color filters.

9. The liquid crystal display device according to claim 7, wherein
the region where the adjacent color filters are not overlapped with each other is smaller than the width of the second light shielding film.

10. The liquid crystal display device according to claim 8, wherein
the region where the adjacent color filters are not overlapped with each other is smaller than the width of the second light shielding film.

11. The liquid crystal display device according to claim 9, wherein
the region where the adjacent color filters are not overlapped with each other is larger than the width of the spacer.

12. The liquid crystal display device according to claim 10, wherein
the region where the adjacent color filters are not overlapped with each other is larger than the width of the spacer.

13. The liquid crystal display device according to claim 11, wherein
the color filters having the same color are formed in a stripe shape in the extending direction of the drain line, the first light shielding film is formed in the extending direction of the drain line, and the second light shielding film is formed in the extending direction of the gate line.

14. The liquid crystal display device according to claim 12, wherein
the color filters having the same color are formed in a stripe shape in the extending direction of the drain line, the first light shielding film is formed in the extending direction of the drain line, and the second light shielding film is formed in the extending direction of the gate line.

15. The liquid crystal display device according to claim 1, wherein
the color filters having the same color are formed in a stripe shape in the extending direction of the drain line, the first light shielding film is formed in the extending direction of the drain line, and the second light shielding film is formed in the extending direction of the gate line.

16. The liquid crystal display device according to claim 2, wherein
the color filters having the same color are formed in a stripe shape in the extending direction of the drain line, the first light shielding film is formed in the extending direction of the drain line, and the second light shielding film is formed in the extending direction of the gate line.

17. The liquid crystal display device according to claim 1, wherein
the region where the adjacent color filters are not overlapped with each other is larger than the width of the spacer.

18. The liquid crystal display device according to claim 2, wherein
the region where the adjacent color filters are not overlapped with each other is larger than the width of the spacer.
